(19) United States
(12) Patent Application Publication
(10) Pub. No.: US 2008/0214398 A1
(43) Pub. Date: Sep. 4, 2008

(54) Herbicidal activities of combinations of sodium azide with sulfur containing and other deactivating compounds

(76) Inventors: Rodrigo Rodriguez-Kabana, Auburn, AL (US); Robert H. Walker, Auburn, AL (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/580,364

(22) Filed: Oct. 13, 2006

Related U.S. Application Data
(60) Provisional application No. 60/726,975, filed on Oct. 14, 2005.

(51) Int. Cl. A01N 59/00

(52) U.S. Cl. 504/188

(57) ABSTRACT

A method of controlling the plant back interval after application of sodium azide. The plant back interval can be significantly shortened by application of a dithiocarbamate, a thiocarbamate, a carbamate, an organic sulfide, an organic disulfide, or an aldehyde, with which the sodium azide may react and become inactivated. These compounds may be applied to soil to deactivate sodium or potassium azide residues and thus allow for immediate planting of a desirable turf or crop, and prevent plant stunting and delayed fruiting of crops without adversely affecting plant growth. The present invention thus provides a method for manipulating the activity period of sodium azide against pests by stopping its activity, when desired, by the application of one or more of these deactivating compounds. The preferred compound is metam sodium which is a dithiocarbamate.

### CROSS REFERENCE TO RELATED APPLICATION

This application claims priority to U.S. Provisional Application No. 60/726,975 filed Oct. 14, 2005.

### BACKGROUND OF THE INVENTION

The present invention relates to herbicides, and more particularly to a method of controlling the activity period of sodium azide in soil by the application of sulfur containing deactivating compounds such as metam sodium.

It is known that sodium azide may be used as a replacement for methyl bromide as an herbicide in the disinfestations of soils. Research has shown sodium azide can be used to replace methyl bromide in many vegetable crops for control of nematodes, weeds, diseases and soil born insects. Recently, research has also shown that sodium azide will substitute for methyl bromide in warm season turf production. Certified turf producers are required to use an effective soil fumigant to eliminate all noxious plants prior to establishing the desired turf cultivar.

It is also known that application of sodium azide as SEP 100^{R} at about 54 gallons per acre provides excellent control of the noxious weeds yellow nutsedge (Cyperus esculentus) and purple nutsedge (Cyperus rotundus). However, when the same rate of sodium azide is combined with metam potassium at about 26 gallons per acre, control of these weeds is lost. This type of interaction between pesticides is referred to as antagonism.

After soil borne pests have been controlled with chemicals, desirable crops are planted. The time between application of the chemical and the planting of crops is referred to as “plant back intervals,” and vary from a few days to a few weeks. These plant back intervals are established through experimentation and are affected by the particular chemicals, soil properties and climatic conditions. Short plant back intervals are desired since they allow for a longer crop growing season.

With regard to sodium azide, a plant back interval of about 3-4 weeks is typically required for successful establishment of warm season turf species. Also, if the appropriate plant back interval is not adhered to, it is known that chemicals such as sodium azide cause plant stunting and delays fruiting in crops such as green peppers. Thus, it is desirable to reduce the plant back interval so that crops can be planted as early as possible after disinfestations, yet at the same time maintain control of soil born pests.

### SUMMARY OF THE INVENTION

The present invention provides a method of controlling the plant back interval after application of sodium azide. The plant back interval can be significantly shortened by application of a dithiocarbamate, a thiocarbamate, a carbamate, an organic sulfide, an organic disulfide, or an aldehyde, with which the sodium azide may react and become inactivated. In other words, these compounds can be used to deactivate sodium and potassium azide residues in soil. These compounds may be applied to soil to deactivate sodium or potassium azide residues and thus allow for immediate planting of a desirable turf or crop, and prevent plant stunting and delayed fruiting of green peppers and similar crops without adversely affecting plant growth. The present invention thus provides a method for manipulating the activity period of sodium azide against pests by stopping its activity, when desired, by the application of one or more of these compounds. The preferred compound is metam sodium which is a thiocarbamate.

The present invention also provides a method of controlling soil borne pests with a combination of sodium azide and the chemical herbicide S-ethyl dipropylthiocarbamate (EPTC). Combinations of sodium azide and EPTC were more herbicidal than either of the two compounds applied alone. Thus, inclusion of EPTC in the treatment of soil with sodium azide will permit significant reductions in the rates of sodium azide needed for satisfactory herbicidal activity.

### BRIEF DESCRIPTION OF THE DRAWINGS

In the drawings:

FIG. 1A is a graph illustrating the effect of pre-plant applications of sodium azide alone and in combination with metam sodium and other sulfur containing compounds on the number of morningglory plants;

FIG. 1B is a graph illustrating the effects of pre-plant applications of sodium azide alone and in combination with metam sodium and other sulfur containing compounds on the fresh weights of morningglory plants;

FIG. 2A is a graph illustrating the interaction between a fixed application rate of metam sodium (60 gallons per acre) and various application rates of sodium azide (40-120 pounds per acre) showing that application of metam sodium to soil previously treated with sodium azide reduces the number of morningglory plants and thus diminishes the herbicidal activity of sodium azide;

FIG. 2B is a graph illustrating the interaction between a fixed application rate of metam sodium (60 gallons per acre) and various application rates of sodium azide (40-120 pounds per acre) showing the effect of application of metam sodium to soil previously treated with sodium azide on the weight of morningglory plants thus also evidencing the diminished herbicidal activity of sodium azide after treatment of with metam sodium;

FIG. 3A is a graph of the number of morningglory plants growing per pot in the experiment of Example 3 ten days after application of various deactivator compounds;

FIG. 3B is a graph of the number of morningglory plants growing per pot in the experiment of Example 3 thirteen days after application of various deactivator compounds;

FIG. 3C is a graph of the number of morningglory plants growing per pot in the experiment of Example 3 twenty six days after application of various deactivator compounds;

FIG. 3D is a graph of the weight of morningglory plants growing per pot in the experiment of Example 3 thirty three days after application of various deactivator compounds;

FIG. 4A is a graph illustrating the effect on the number of morningglory plants per pot in the experiment of Example 4 thirteen days after applying metam sodium to soil at 0 gal/acre and 60 gal/acre in combination with various sodium azide doses;

FIG. 4B is a graph illustrating the effect on the number of morningglory plants per pot in the experiment of Example 4 seventeen days after applying metam sodium to soil at 0 gal/acre and 60 gal/acre in combination with various sodium azide doses; and

FIG. 4C is a graph illustrating the effect on the number of morningglory plants per pot in the experiment of Example 4 thirty days after applying metam sodium to soil at 0 gal/acre and 60 gal/acre in combination with various sodium azide doses.

### DETAILED DESCRIPTION OF THE INVENTION

The present invention provides a method of controlling the herbicidal activity period of sodium azide, which includes the steps of applying sodium azide to soil, and thereafter applying a deactivating compound to the soil so that the sodium azide reacts therewith and becomes inactivated. The present invention thus provides a method for manipulating the activity period of sodium azide against pests by stopping its activity, when desired, by the application of one or more deactivating compounds. As a result, the plant back interval after application of sodium azide can be controlled, and preferably be significantly shortened by application of one or more of these deactivating compounds.

Sodium azide is a well known azide having the chemical formula NaN₃. Sodium azide has numerous industrial uses, particularly in agriculture where it is used as a soil sterilizing agent, fungicide, and herbicide. It is particularly affective against nematodes. It is available from numerous sources, one of which is American Pacific Corp. under the trade designation SEP 100. Sodium azide is typically applied to soil at a rate of 5 to 200 lbs/acre in order to be effective. The rate of application depends upon numerous factors such as type of soil, the pesticide to be controlled, and other well known factors.

Sodium azide effectively controls unwanted grasses and broad leafs, nutsedge, pigweed, sickle pod and many other weeds. It is also very effective in controlling sting, rootknot, stubby root, dagger, and lesion nematodes as well as many damaging fungi and bacteria. Sodium azide has been effectively tested on cut flowers, turf and sod, strawberries, tomatoes, cucurbits, eggplant, potatoes and peppers.

The deactivating compound may be any organic compound that reacts with the sodium azide to inactivate the sodium azide. The deactivating compound is preferably a sulfur containing compound, and is selected from the group consisting of a dithiocarbamate, a thiocarbamate, a carbamate, an organic sulfide, an organic disulfide, an aldehyde, and mixtures of these compounds. The deactivating compound is preferably applied to soil at a rate of 1 to 500 lbs/acre. The amount of deactivating compound applied to soil is sufficient to react with the sodium azide to effectively inactivate the sodium azide. The amount thus depends upon the rate of sodium azide previously applied to soil as well as other factors such as the plant back time interval desired.

Examples of dithiocarbamates that may be employed include sodium methyl dithiocarbamate (metam sodium) and metam potassium. The preferred dithiocarbamate is metam sodium.

Examples of thiocarbamates include S-ethyl-dipropylthiocarbamate (EPTC), S-propyl butyl ethylthiocarbamate (pebulate), S-propyl dipropylthiocarbamate (vemolate), and S-ethyl diisobutylthiocarbamate (butylate). The preferred thiocarbamate is EPTC.

Examples of carbamates include 1-naphthyl methyl carbamate (carbaryl), 2,3-dihydro-2,2-dimethyl-7-benzofuranyl methyl-carbamate (carbofuran), and 2-methyl-2-(methylthio) propionaldehyde O-(methylcarbamoyl)oxime(aldicarb). The preferred carbamate is carbaryl.

Examples of organic sulfides include aliphatic and aromatic sulfides such as methyl sulfide, methyl propyl sulfide, isopropyl sulfide, phenyl sulfide, and methyl phenyl sulfide. The preferred organic sulfide is methyl sulfide. Examples of organic disulfides include methyldisulfide, diallyl disulfide, and allyl propyl disulfide. The preferred organic disulfide is methyldisulfide.

Examples of aldehydes useful in the present invention include acrolein, crotonaldehyde, furfuraldehyde, benzaldehyde, and citral. The preferred aldehyde is acrolein.

Both the sodium azide and the deactivating compound are usually applied to soil as an aqueous solution containing the active ingredient. Typically, the sodium azide will be applied first, and then after the plant back interval desired, the deactivating compound is applied. In solution, sodium azide is applied using drip irrigation systems, or sprayed and rototilled into soil beds. Thereafter, immediate planting of a desired turf or crop may be performed without adversely affecting plant growth.

In another aspect of the present invention, a method of controlling soil-borne pests with a combination of sodium azide and the chemical herbicide S-ethyl dipropylthiocarbamate (EPTC) is provided. As demonstrated in the following Examples, combinations of sodium azide and EPTC were more herbicidal than either of the two compounds applied alone. Thus, inclusion of EPTC in the treatment of soil with sodium azide will permit significant reductions in the rates of sodium azide needed for effective herbicidal activity. In this aspect of the invention, the sodium azide and EPTC may be applied simultaneously to the soil, or if desired, applied at different times to the soil. The sodium azide and EPTC are both preferably applied as aqueous solutions containing the active ingredient. The sodium azide is preferably applied at a rate of 5 to 200 lbs a.i./acre, while the EPTC is preferably applied at a rate of 1 to 10 lbs a.i./acre.

The invention is further described and illustrated by way of the specific examples that are set forth below.

### EXAMPLE 1

The effects on herbicidal activity of combinations of SEP 100 (Na azide) with metam Na, Na thiosulfate, methyl disulfide and the herbicide EPTC (Eptam 7E, Eradicane 6.7E) were studied in greenhouse experiments. In a first experiment SEP 100 was applied by drenching (1″ acre water) at 150 lbs a.i./A to pots (4 inch diam; PVC) containing each 2.2 pounds of silt loam (pH 6.2; org. matter <1.0%) from a cotton field. Immediately after treatment each pot was covered with a clear polyethylene bag (1.5 mil). The bags were removed 4 days after, and additional applications were drenched in with: Vapam HL, at 120 gal/A; EPTC at 8 and 10 lbs ai/A; Na thiosulfate at 200 and 300 lbs ai/A; and methyl disulfide at 300 lbs ai/A. Pots were again covered with the bags for 3 days after which they were removed and pots planted with annual morningglory (Ipomoea spp.; 25 seed/pot). Some pots received only SEP 100 and others received water only. Each treatment was represented by 7 pots (experimental units) arranged in a randomized complete block design on a bench. The number of plants in each pot was determined at 10, 13, and 26 days after application of SEP 100. Momingglory plant tops were collected from each pot 33 days after initiation of the experiment and their fresh weight was determined.

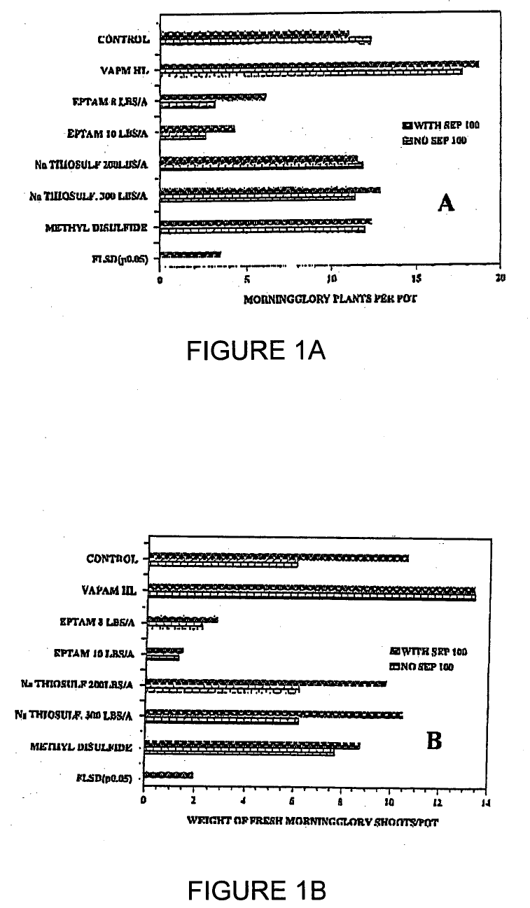

Applications of Vapam HL to SEP 100-treated soil significantly reduced herbicidal activity of Na azide (FIG. 1A). There was evidence that the combination of SEP 100 and metam Na resulted in improved morningglory growth over that obtained with SEP 100 alone (FIG. 1B). EPTC was strongly herbicidal against morningglory and initially its combination with SEP 100 more so than EPTC alone. Na thiosulfate and methyl disulfide applications had little effect on herbicidal activity of SEP 100.

### EXAMPLE 2

A second experiment explored the interaction between a fixed rate of Vapam HL (60 gal/A) and applications of SEP 100 in the 40-120 lbs a.i./A range. The methods and procedure followed were as for the first experiment except that weed counts were taken at 13 and 17 days after application and plant top weights were determined 32 days after initiation of the experiment.

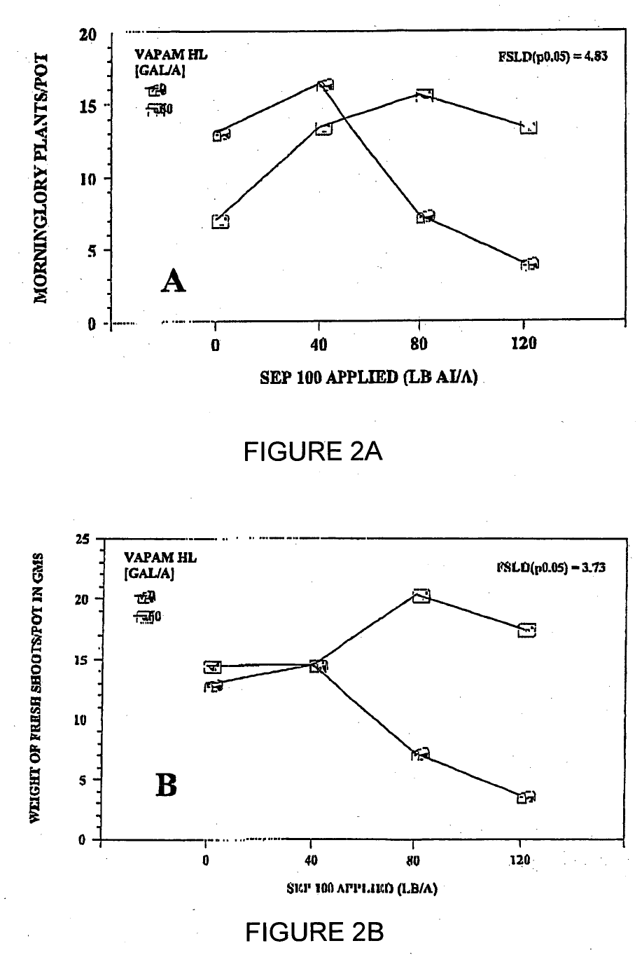

Applications of Vapam HL to soil treated with SEP 100 again diminished the herbicidal activity of Na azide (FIG. 2A). Data on top weights suggest a clear antagonistic effect derived from the application of Vapam HL to soil previously treated with Na azide (FIG. 2B).

Conclusions: Results of Examples 1 and 2 suggest that metam Na can be used after application of SEP 100 to neutralize residual Na azide in the soil. Combinations of EPTC and Na azide were more herbicidal than either of the two compounds applied alone. Inclusion of EPTC in the treatment of soil with Na azide could permit significant reductions in the rates of Na azide needed for satisfactory herbicidal activity.

### EXAMPLE 3

Compounds: Sodium azide, metam sodium (Vapam HL), EPTC, sodium thiosulfate, and methyl disulfide were delivered in aqueous solutions or emulsions (5% of SEP 100 for sodium azide; 5% for Vapam; 0.25% for EPTC, 2.5% for sodium thiosulfate; 2.5% for methyl disulfide) prepared immediately before use by diluting in demineralized water while stirring with a magnetic stirrer.

Sources: SEP 100 from American Pacific Corp., metam sodium as Vapam HL (32, 7% a.i.) from AMVAC, EPTC from Gowen, sodium thiosulfate and methyl disulfide from Aldrich.

Rates: Metam sodium at 163.5 mgs a.i./kg soil-equivalent to 0, and 327 lbs a.i./acre (120 gal Vapam HL/A). Sodium azide at 75 mgs a.i./kg soil equivalent to 150 lbs a.i./A, sodium thiosulfate at 200 and 300 lbs/A; EPTC at 8 and 10 lbs/A, and methyl disulfide at 300 lbs/A.

All different possible combinations of sodium azide with the other deactivating compounds and their corresponding rates were included in the experiment together with the appropriate controls.

Application Method and Procedure: Each treatment was delivered by drenching in 100 mls aqueous volume onto the soil surface in pots (10-cm diam; PVC) containing 1 kg soil. The soil was from a cotton field (silt loam; pH 6.2; CEC<10 meq/100 gm soil; org. matter <1.0%). Sodium azide was applied on day one, and the other compounds four days later. Immediately after treatment the pots were covered by a thick (1.5 mil) clear low density polyethylene bag held tight against the outer wall of the pot by a rubber band. Three days after application of “deactivator compounds” the bags were removed and the pots were planted with morningglory seed (25 seed/pot). Counts were taken from each pot (experimental unit) at 10, 13, and 26 days after application of sodium azide. Morningglory plant tops were collected from each pot 33 days after initiation of the experiment and fresh weights were determined.

Major Pests: Morningglory (Ipomoea spp.)

Experimental Design: Randomized complete block with seven replications/treatment.

Statistical Analyses: Anova and Fischer's least significant difference (flsd) at p 0.05. Regression analyses.

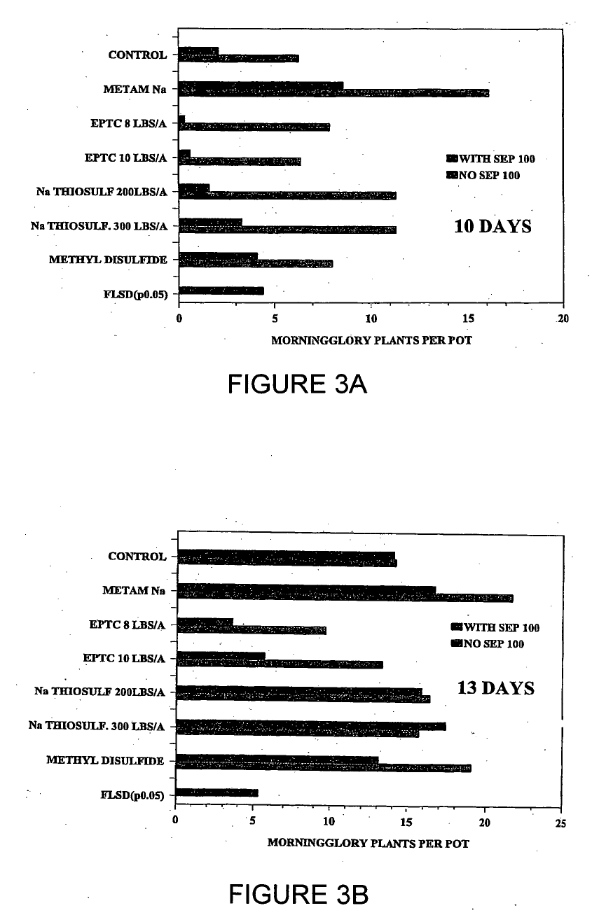

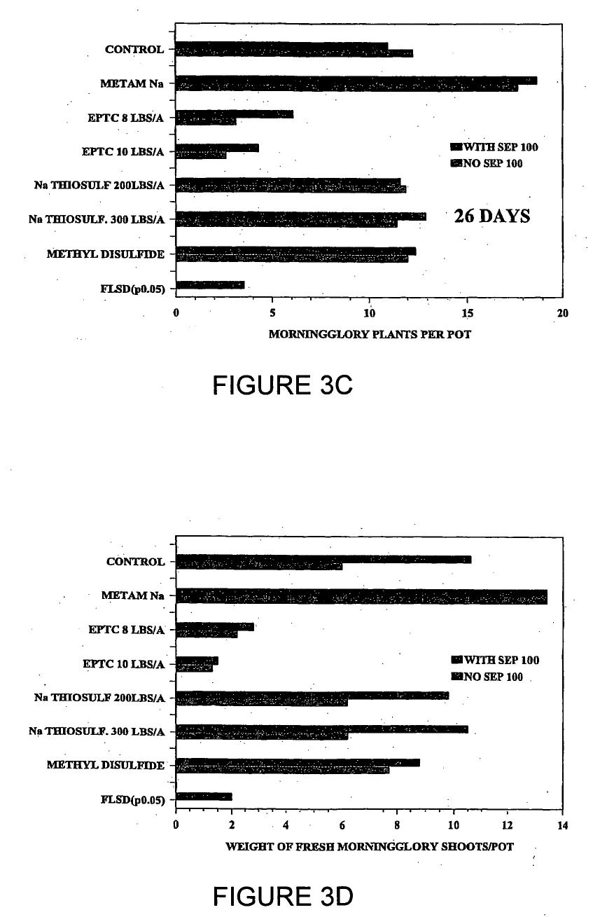

Results: The data in FIGS. 3A, 3B, 3C and 3D demonstrate:

(1) Applications of metam sodium to azide-treated soil significantly reduced the herbicidal activity of sodium azide.

(2) There was evidence that the combination of sodium azide and metam sodium resulted in improved morningglory growth over that obtained with sodium azide alone.

(3) EPTC was strongly herbicidal against morningglory and initially the combination with azide more so than EPTC alone.

(4) Results with sodium thiosulfate and methyl disulfide were inconclusive.

Results:

Applications of metam sodium to azide-treated soil nullified the herbicidal activity of sodium azide (FIGS. 3A-3C).

Data on morningglory top weights (FIG. 3D) indicate synergistic beneficial effects derived from the application of metam sodium to soil previously treated with sodium azide.

Conclusions:

Results show that metam sodium can be used after application of SEP 100 to eliminate residual sodium azide in the soil.

Combinations of EPTC with sodium azide were much more herbicidal than either of the two compounds used alone-there was evidence for synergy.

Use of EPTC would permit significant reductions in the rates of sodium azide needed for satisfactory herbicidal activity.

### EXAMPLE 4

The following experiment was performed to confirm the results obtained from Experiment 1:

Compounds: sodium azide and metam sodium (Vapam HL) were delivered in aqueous solutions (1.0% of SEP 100 for sodium azide; 5% for Vapam) prepared immediately before use by diluting in demineralized water while stirring with a magnetic stirrer.

Source: SEP 100 from American Pacific Corp., and metam sodium as Vapam HL (32, 7% a.i.) from AMVAC.

Rates: Metam sodium at 0, and 82 mgs a.i./kg soil-equivalent to 0, and 60 gal/A. Sodium azide at 0, 20, 40 and 60 mgs a.i./kg soil equivalent to 0, 40, 80, and 120 lbs a.i./A, respectively. Each metam sodium rate was applied to soil in combination with each sodium azide dose.

Application Method and Procedure:

Same as Example 1.

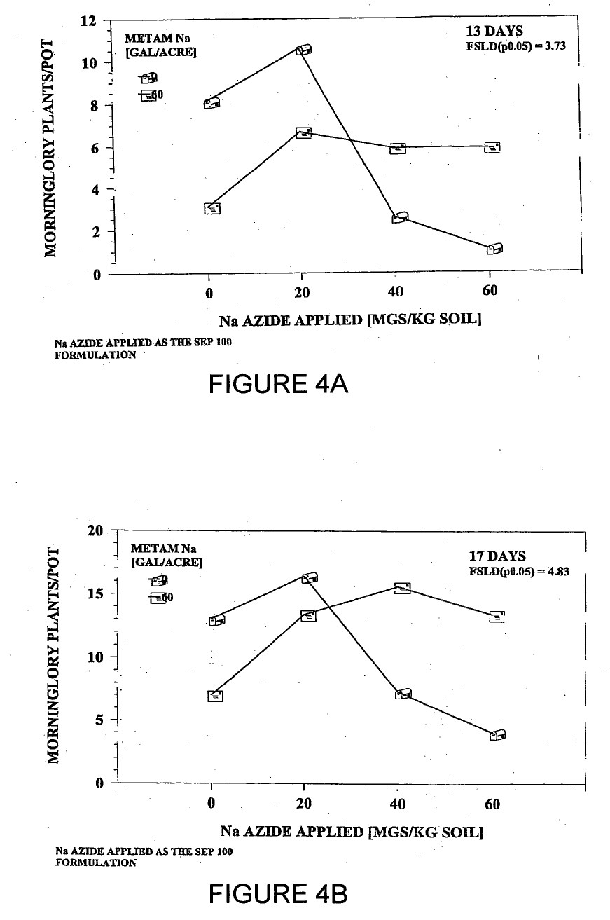

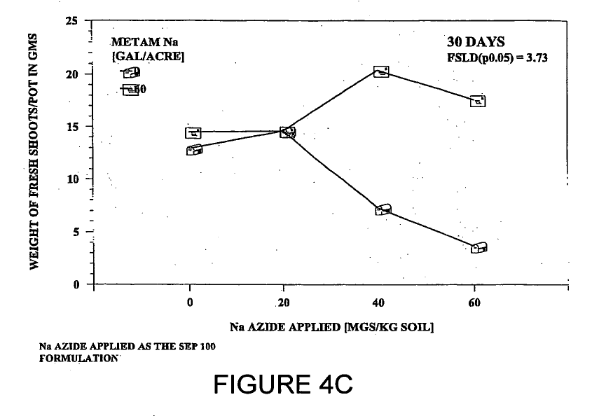

Results: The data in FIGS. 4A, 4B and 4C demonstrate:

(1) Applications of metam sodium to azide-treated soil nullified the herbicidal activity of sodium azide.

(2) Data on morningglory top weights indicate synergistic beneficial effects derived from the application of metam sodium to soil previously treated with sodium azide.

Conclusions:

Results show that metam sodium can be used after application of SEP 100 to eliminate residual sodium azide in the soil.

The addition of metam sodium to azide-treated soil may serve to enhance plant growth above what is obtained with sodium azide alone.

I claim:

1. A method of controlling the herbicidal activity period of sodium azide, comprising the steps of:
applying sodium azide to soil; and
thereafter applying a deactivating compound to the soil so that the sodium azide reacts therewith and becomes inactivated.

2. The method of claim 1 wherein the deactivating compound is selected from the group consisting of a dithiocarbamate, a thiocarbamate, a carbamate, an organic sulfide, an organic disulfide, an aldehyde, and mixtures thereof.

3. The method of claim 1 wherein the deactivating compound is metam sodium applied at rates of 40 to 500 lbs/acre.

4. The method of claim 1 wherein the deactivating compound is sodium thiosulfate applied at rates of 100 to 300 lbs/acre.

5. The method of claim 1 wherein the deactivating compound is methyl disulfide applied at 100 to 300 lbs/acre.

6. The method of claim 1 wherein the deactivating compound is S-ethyl-dipropylthiocarbamate applied at 1-10 lbs a.i./acre.

7. The method of claim 1 wherein the deactivating compound is applied at a rate of 1 to 500 lbs/acre.

8. A method of controlling soil borne pests, comprising the steps of:
applying sodium azide to soil; and
applying S-ethyl-dipropylthiocarbamate to the soil.

9. The method of claim 8 wherein the sodium azide and S-ethyl-dipropylthiocarbamate are applied simultaneously to the soil.

10. The method of claim 8 wherein the sodium azide and S-ethyl-dipropylthiocarbamate are applied at different times to the soil.

11. The method of claim 8 wherein the sodium azide is applied at a rate of 5 to 200 lbs a.i./acre.

12. The method of claim 8 wherein the S-ethyl-dipropylthiocarbamate is applied at a rate of 1 to 10 lbs a.i./acre.
